(19) United States
(12) Patent Application Publication
(10) Pub. No.: US 2015/0149295 A1
(43) Pub. Date: May 28, 2015

(54) METHOD AND SYSTEM FOR GENERATING RECOMMENDATIONS BASED ON MEDIA USAGE AND PURCHASE BEHAVIOR

(71) Applicant: Kobo Incorporated, Toronto (CA)

(72) Inventors: Darius BRAZIUNAS, Toronto (CA); Jordan CHRISTENSEN, Toronto (CA)

(73) Assignee: Kobo Incorporated, Toronto (CA)

(21) Appl. No.: 14/089,407

(22) Filed: Nov. 25, 2013

(51) Int. Cl. G06Q 30/02; G06F 17/30

(52) U.S. Cl. CPC G06Q 30/0269; G06F 17/30876
USPC 705/14.66

(57) ABSTRACT

A server generates item recommendation lists for users, whose behaviors are registered related to user library items and assigned relevance in relation to available inventory items. First, similarity computed between any pair of inventory items based on user-specific relevance factors. Second, similarity is measured between inventory items by over content and/or metadata corresponding to the inventory items. Overall similarity is computed between the library and the available inventory items based on a sum of the first and second measured similarities. Available inventory items are recommended based on the computed overall similarity score. Relevance, which may diminish over a time, may be assigned based on behavior type and duration.

### RELATED U.S. APPLICATION

The present application relates to co-pending U.S. patent application Ser. No. 13/926,999 filed Jun. 25, 2013 by Darius Braziunas and Jordan Christensen for Methods and Systems for Generating Recommendation Lists with Diversity, which is assigned to the present Assignee and incorporated by reference for all purposes as if fully set forth herein.

### TECHNOLOGY

The present disclosure relates generally to the field of e-commerce (“electronic commerce”) marketing. More specifically, an example embodiment of the present invention relates to automatic generation of recommended items for user purchase or use.

### BACKGROUND

Presenting customized recommendation lists of relevant products based on individual consumers' shopping behavior patterns has become increasingly significant in e-commerce. Such customized recommendations are effective for attracting and retaining consumers. Collaborative filtering (CF) may be useful in the automatic generation of recommendations. CF recommendations are typically made based on a user's manifested preferences, such as satisfaction ratings that may be expressed in relation to particular products.

Approaches described in this section may, but have not necessarily been conceived or pursued previously. Unless otherwise indicated, approaches mentioned (or issues identified in relation thereto) should not to be assumed as recognized in any prior art merely by inclusion in this section.

### SUMMARY

It would be advantageous to provide a mechanism of automatically generating user-specific recommendation lists relevant items based on a user's past behavior. Accordingly, embodiments of the present disclosure employ computer implemented methods of generating a recommendation list of available inventory items based on multiple data inputs, including purchase and other behavior relating to each item in a user library.

An example embodiment of the present invention relates to a server implemented process for automatically computing a recommendation list of items for a user of a client computer such as an e-book reader, a media player, a pad, palm, laptop or other computer apparatus, a telephone or the like. Each of multiple behaviors performed by the user is registered in relation to each of multiple items of a library associated with the user. The system assigns a relevance factor for information associated with each of the registered user behaviors in relation to each of multiple items of an available inventory of items. A first similarity value is collaborative-filtering based item-to-item similarity value that uses different user-specific relevance factors.

In an example embodiment, a second similarity value is measured between each of multiple pairs of all items based on content and a third similarity value is measured between each of the all multiple item pairs based on metadata. An overall similarity score between any pair of the multiple available inventory items is computed based on a sum of the first measured similarity value, the second content based similarity value and the third metadata based similarity value.

A recommendation list of the available inventory items is generated for recommendation based on the computed overall similarity score.

And example embodiment assigns relevance values based on a type and duration of each of the user behaviors and may diminish over a passage of time between a latest occurrence of a user-item interaction associated with the behavior and the present time.

An example embodiment relates to a non-transitory computer-readable storage medium embodying instructions that, when executed by a processing device, cause, control, program or configure a server or other computer to operably perform processing associated with a server implemented process for computing a recommendation list of items for a user of a client, as described above.

An example embodiment relates to a server computer, which comprises a processor and a non-transitory computer-readable storage medium embodying instructions that, when executed by the processor cause, control, program or configure the server to operably perform processing associated with a server implemented process for computing a recommendation list of items for a user of a client, as described above.

Thus, example embodiments are operable to improve recommendation performance and increase user purchases accordingly. This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting description of example embodiments set forth below.

### BRIEF DESCRIPTION OF THE DRAWINGS

Embodiments of the present invention are described herein with reference to the accompanying drawing figures. Unless stated otherwise, no particular scale is used. In each figure (FIG.) of these drawings, like reference characters refer to like elements.

FIG. 1 depicts an example communication network, according to an embodiment of the present invention.

FIG. 2 depicts an example server apparatus, according to an embodiment of the present invention.

FIG. 3 depicts a flow chart for an example server implemented process for computing a recommendation list, according to an embodiment of the present invention.

FIG. 4 depicts a flow chart for an example server implemented process for registering user behaviors, according to an embodiment of the present invention.

FIG. 5 depicts a flow chart for an example server implemented process for assigning relevance to registered user behaviors, according to an embodiment of the present invention.

FIG. 6 depicts an example process e-book reader, according to an embodiment of the present invention.

FIG. 7 depicts an example process data flow, according to an embodiment of the present invention.

### DESCRIPTION OF EXAMPLE EMBODIMENTS

Reference will now be made in detail to example embodiments of the present invention, examples of which are illustrated in the accompanying drawing figures. While embodiments of the present invention are described in conjunction with the example embodiments herein, it should be understood that they are not intended to limit embodiments of the invention to these particular example embodiments. On the contrary, the invention is intended and well-suited to cover alternatives, modifications and equivalents, which may be included within the spirit and scope of the invention as defined by the appended claims. Furthermore, in the following description of example embodiments, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure, obstruct, obfuscate or occlude possibly somewhat more germane or relevant aspects of an example embodiment.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “assigning” or “ascribing” or measuring” or “computing” or “listing” or “processing” or “accessing” or “executing” or “storing” or “registering” or “rendering” or “retrieving” or “timing” or “determining” or “tracking” or “diminishing” or the like, refer to the operation, action and processes of a server or other computer system, or similar electronic computing device, which manipulates and transforms data represented as physical transformations, electronic material states, voltage and other electrical levels, electronic digital quantities and/or binary numerical values written to, stored within and read from the computer system's registers, latches, buffers, memories, drives and other non-transitory computer readable media into other data similarly represented as not dissimilar physical quantities, etc. within the computer system memories or registers, drives, etc. or other such non-transitory information storage, transmission or display devices. When a component or action is discussed in several portions of the description of example embodiments herein, the use of the same reference numeral signifies that the component or action comprises a like component or action as described in an earlier portion of the description.

An example embodiment of the present invention relates to a server implemented process for computing a recommendation list of items for a user of a client. Each of multiple behaviors performed by the user is registered in relation to each of a plurality of items of a library associated with the user assigns a relevance factor for information associated with each of the registered user behaviors in relation to each of multiple items of an available inventory of items.

In an example embodiment, a second and third similarity value is measured between each of the multiple user library items and each of the multiple available inventory items based on content and/or metadata corresponding to each item of the user library and of the available inventory. An overall similarity score between each of the multiple user library items and each of the multiple available inventory items is computed based on a sum of the first measured similarity value and the second measured similarity value. A recommendation list of the available inventory items is listed for inclusion in the user library based on the computed overall similarity score.

An example embodiment assigns relevance values based on a type and duration of user behavior, which may diminish over a passage of time between a latest occurrence of a user-item interaction associated with a registered behavior and present.

An example embodiment may be implemented in which a similarity between pairs of items is computed and in which collaborative filtering (CF) is applied over the computed similarities to recommend to a user. The similarity may be computed as described in related co-pending U.S. patent application Ser. No. 13/926,999 filed Jun. 25, 2013 by Darius Braziunas and Jordan Christensen for Methods and Systems for Generating Recommendation Lists with Diversity, which is incorporated herein by reference.

A first item of each item pair corresponds to an item of a user's library of multiple items. A second item of each item pair corresponds to an item of an inventory of available items, such as a catalog or sales inventory. This item-to-item similarity is computed between each of the items of each item pair based on purchase patterns (e.g., BPEs) or other behaviors exhibited by a user and/or characteristics of each item of the item pair. A list of recommended available items of the inventory is computed for the user, based on items of the user's library purchased by the user and/or items that the user interacted with (e.g., without purchase thereof).

For example, U represents a set comprising all users. A user u of the user set U is associated with (e.g., assembles, acquires, builds, possesses, maintains, etc.) a user library lᵤ, which represents a set of library items j with which the user u may interact. The user u interacts with each item j of the set of library items lᵤ. An item i may comprise a particular item of a set J of all available items in an inventory of items.

Using CF, a similarity may thus be computed between an inventory item i and a library item j of an item pair (i, j) according to Equation 1, below.

$$s ( i , j ) = \frac{{\sum }_{u} {P}_{ui} {P}_{uj}}{\sqrt{{\sum }_{u} {P}_{ui }^{2}} \sqrt{{\sum }_{u} {P}_{uj}^{2}}} \qquad ( Equation 1. )$$

In Equation 1, the term Pᵤᵢ represents a non-zero value if information characterizes a relationship between the user u and the item i and the term Pᵤⱼ represents a non-zero value, if information characterizes a relationship between the user u and the item j. A zero value for the term Pᵤᵢ or the term Pᵤⱼ thus represents a lack of information, with which any such user-item relationship may be characterized. An example embodiment may be implemented in which such relationship characteristic information comprises data related to a purchase event associated with the user and the item i or the item j, or data returned from the user as feedback in relation to the item l or the item j.

In an example embodiment of the present invention, the server obtains values for Pᵤᵢ and Pᵤⱼ by registering any or all of a variety of interactions, which occur between users u and the items j, and from the similarities computed by CF between the items i and the items j. As the term is applied herein, “registering” may relate or refer to observing, recording, capturing, rating, scoring and/or evaluating an information value to various interactions between the users and the items. The information value may relate to various user behaviors, which may be registered in relation to specific items of the user's library (and/or the available item inventory).

An example embodiment is implemented in which a numerical value level such as 0-100, inclusive, is assigned in relation to the registering of each of multiple, various user-item interactions. A zero value indicates a lack of information value in relation to a particular user-item interaction. At the opposite extreme, a value of 100 ascribes a complete or total information relevance value to a user-item interaction so registered.

Registering user-item interactions comprises assigning the numerical values to each of the items j of the user library lᵤ based on any or all of the various user behaviors, which are observed, recorded, captured, rated and/or evaluated in relation to each of the items j and the items i. An example embodiment is implemented in which a server registers the user behaviors. The server registers the user behaviors based on transactions executed between the server and a user's client computer 16, which is operable for transacting interactions with the server over a mutual communications network.

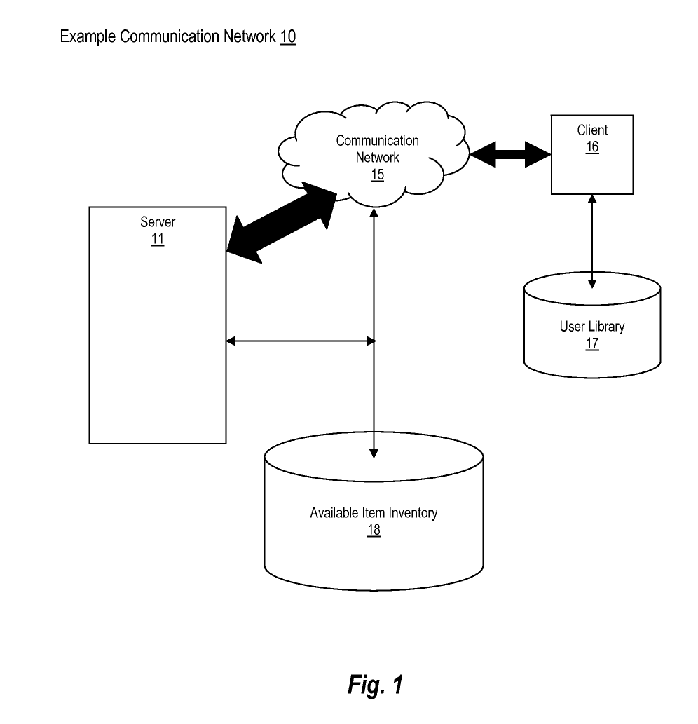

FIG. 1 depicts an example communication system 10. Communication system 10 comprises a communications network 15, which allows a server 11 to interact with a client computer 16. The server 11 may interact with the available item inventory 18 directly or via the network 15. A user library 17 is associated with the client computer 16. Multiple client computers (clients) may comprise components of system 10 and may thus interact with server 11 via the network 15.

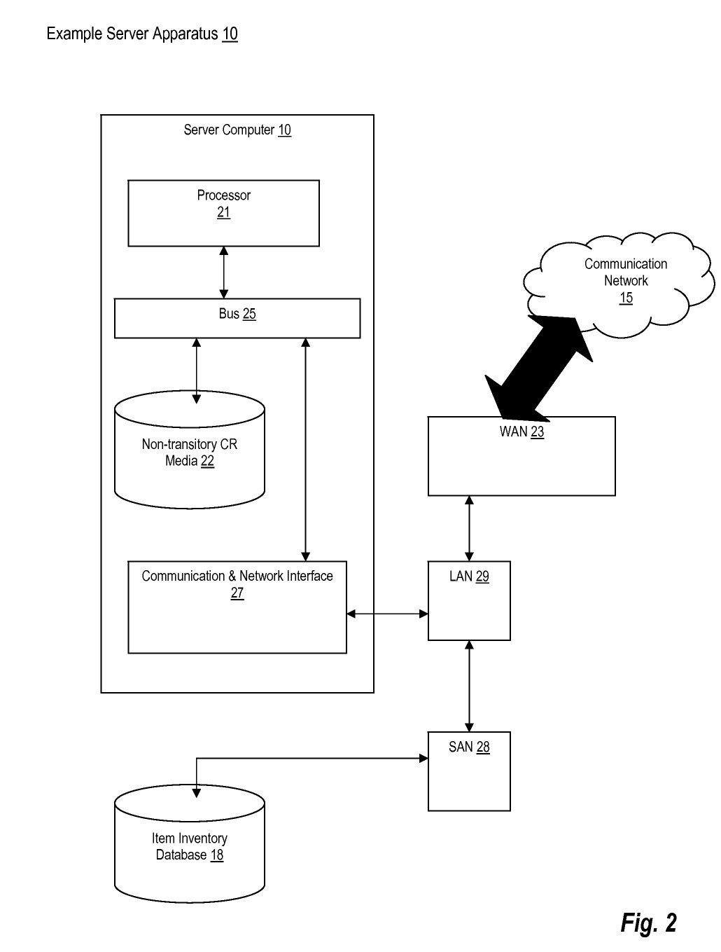

FIG. 2 depicts an example server computer apparatus 11, according to an embodiment of the present invention. The server 11 comprises a bus 25, which electrically and communicatively couples the other components and allows their interaction. At least one processor 21 is coupled to the bus and is operable for executing code, tangibly stored and accessed from non-transitory computer readable media 22. Computer readable medium 22 may comprise memory, disk or flash drive storage, installed or removal storage, and/or other non-transitory media. A communication and network interface 27 allows server 11 to interact with item inventory 18 and with various clients over communication system 10.

The communications system 10 may comprise, at least in part, the internet, a cellular or other telephone network, a wide area network (WAN) 23, a local area network (LAN) 29, a private or partially private, subscription or commercial network, a storage area network (SAN) 28 and/or another network communicatively mutual to the server computer and any number of client computers.

The server 11 registers the user-item based on transactions with the user's client computer 16. The client computers may comprise e-book readers, pad, laptop or other computers, cellular telephones (e.g., smart phones), personal digital assistants (PDAs), media (audio/video) receivers and players, televisions, personal video recorders (PVRs), game controllers, and/or other consumer or professional electronic devices, with which a server may transact user-item interactions with the clients. The server 11 is operable for computing a recommendation list of items for a user of a client 16.

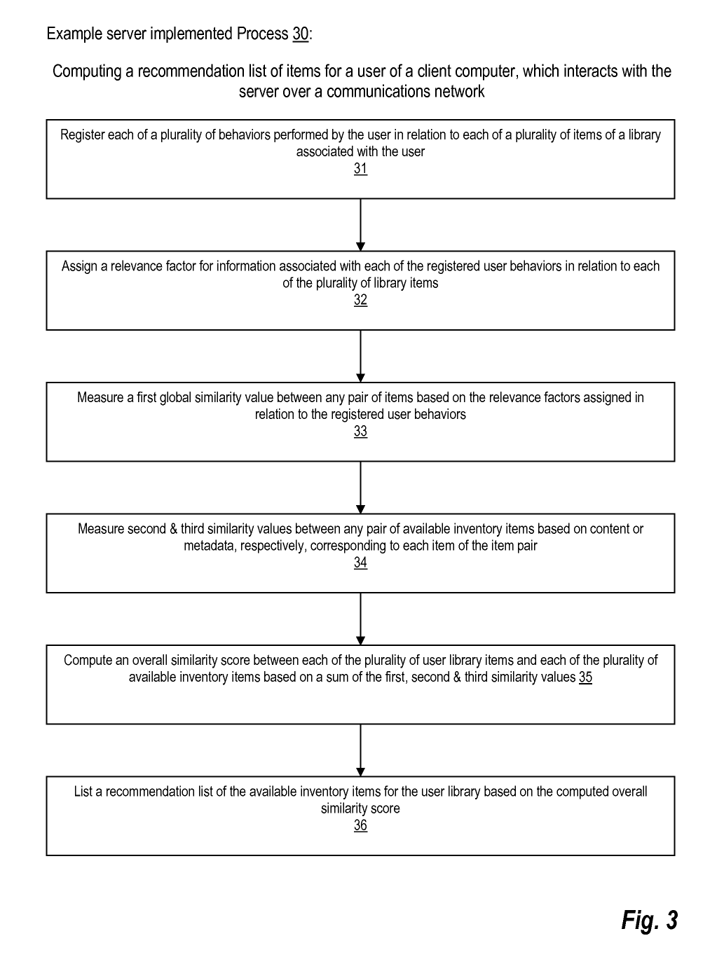

FIG. 3 depicts an example server implemented process 30 for recommending items to the user of a client. In step 31, each of multiple (e.g., a plurality of) behaviors performed by the user in relation to each of multiple items of a library associated with the user are registered. An example embodiment is implemented in which the server 11 registers user-item transactions based on receiving data from the client computer 16 in relation to the user behaviors.

In step 32, the server 11 assigns a relevance factor for information associated with each of the registered user behaviors in relation to each of the multiple user library items of an available inventory of items. The server 11 computes a relevance level of information related to the user behavior data from each of the various user behaviors.

In step 33, the server 11 measures a first similarity value between any pair of items (e.g., multiple user library items and/or multiple available inventory items) based on the assigned relevance factors globally, e.g., for a population comprising all users.

In step 34, the server 11 measures a second similarity value between any pair of items and each of the multiple available inventory items globally based on content and a third similarity value between any pair of items and each of the multiple available inventory items globally based on metadata. The content and metadata correspond to each item of the item pairs. In an example embodiment, the step 34 may be performed prior in time to performing any of the steps 31-33, inclusive.

In step 35, the server 11 computes an overall similarity score between each of the multiple user library items and each of the multiple available inventory items based on a weighted sum of the first measured similarity value, the second content based similarity value and the third metadata based similarity value. For example, the server 11 may compute a similarity measurement s(i,j) based on the combined relevance values of each of the user behaviors, which may be combined with the global media content and metadata related similarity data.

In an example embodiment of the present invention, the server 11 assigns the information values Pᵤᵢ and Pᵤⱼ thereto according to transactional data associated with the user behaviors, which is received from client 16 and evaluated by the server 11. The transactional data related to assigning relevance levels of the user behaviors s(i,j) comprises user feedback data and/or media interaction significance data information relevance level. These transaction data may be combined with global item-to-item significance data.

The server 11 may receive computed (or compute) the global media content similarity data in relation to explicit and implicit similarities between content of one or more items of the user library 17 and content of each of the available inventory 18 items. The global media content similarity may be computed from measurement of similarities s_{T}(i,j) between actual content (e.g., e-book text) and/or content-related metadata similarity s_{M}(i,j) relating to the library items and each of the available inventory 18 items.

An example embodiment is described in relation to book media, such as an e-book (“electronic book”), in which the content comprises text. Text associated with an e-book may be stored, transmitted, accessed and/or rendered electronically with an e-book reader device, a pad computer or another client computer 16 instance with which the server 11 interacts.

While example embodiments are described herein with reference to e-books, artisans skilled ordinarily in technology relating to retrieving, processing, rendering and recommending media and other information, library science, e-commerce, network-based commerce, marketing or the like should realize however that this description is illustrative but not limiting. On the contrary, example embodiments are well suited for use with other media in addition to or beside e-books, such as audio, video, audio/video and other mixed media or “multimedia,” or the like. Thus, an example embodiment may be implemented in relation to user behaviors with books, music, movies, games, or another information media such as legacy (print-based) books, music or other CDs (compact disks), movie BD/DVDs (Blu-ray/digital versatile disks), etc. Table 1 below lists some examples, without limitation, of user behaviors that may be registered by the system.

TABLE 1
Start and end times of each media use session (e.g., commencing and
concluding an individual reading session of a certain e-book on
an e-book reader)
Whole media item start and finish events (e.g., completing an e-book
after beginning on an e-book reader
Highlighting, selecting or copying a portion of media content (e.g.,
highlighting a word or phrase of e-text of an e-book with an e-book
reader)
Sharing information about a media item (e.g., data or a link to an e-book,
CD, DVD/BD, etc.) on a social network (e.g., LinkedIn ™,
Facebook ™, etc.)
Bookmarking events

In an example embodiment, the server 11 receives feedback related transactional data, which a client computer 16 communicates to the server 11 based on an explicit descriptor input given by its user relation to one or more of the items i. The explicit descriptor may comprise a rating of how highly the user considers a quality level of the book or other media to reach, how much the user enjoyed an experience with the media content, objectively and/or subjectively, how helpful a user considers information provided by the media or the like. For example, the server may register a rating of one (low level) to five or more (high level) “stars,” “likes,” or another express rating objectifier related input from a transaction with the client computer 16 via the communication network 15.

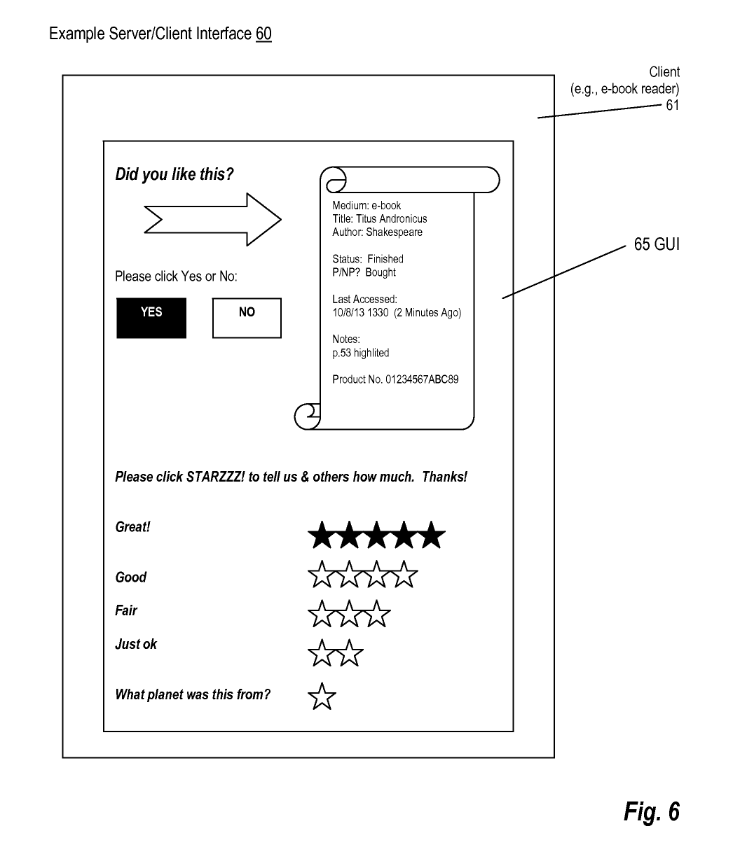

The server 11 may receive feedback related data and other user behavior from the client 16, which a user may be input thereto using a graphical user interface (GUI), a haptic interface or GUI/haptic interface and/or another interface. FIG. 6 depicts an example client/server interface 60, according to an embodiment of the present invention. A client 61, such as an e-book reader, renders an interactive GUI 65. A user uses the interactive features of the GUI to “rate,” e.g., provide feedback in relation to an item. Table 2 below lists some examples, without limitation, of explicit user feedback that may be registered by the system.

TABLE 2
A rating (e.g., 1-5 “stars”) of a media item (e.g., an e-book)
made by a client (e.g., e-book reader)
“Not interested” feedback
“Get preview” feedback
“Already used” feedback (e.g., that an e-book was already read)
“Add to wish-list” feedback
A purchase event (e.g., buying an e-book with an e-reader)
A non-purchase (e.g., free) download event
Browsing a website associated with a media item (e.g., browsing a web
page about an e-book)
Activating (e.g., “clicking”) a link (e.g., a hyperlink) associated
with a media item

The feedback may relate to an explicit input as to whether the user liked the item or not, and a level of “stars” or the like, with which the user may rank, rate, grade or score an item, subjectively and/or objectively in relation to another item or items. The client e-book reader 61 provides the feedback related data to the server 11 via the network 15. The GUI 65 may also present data about a particular item and/or provide such data (including timing & duration data) in relation thereto to the server 11.

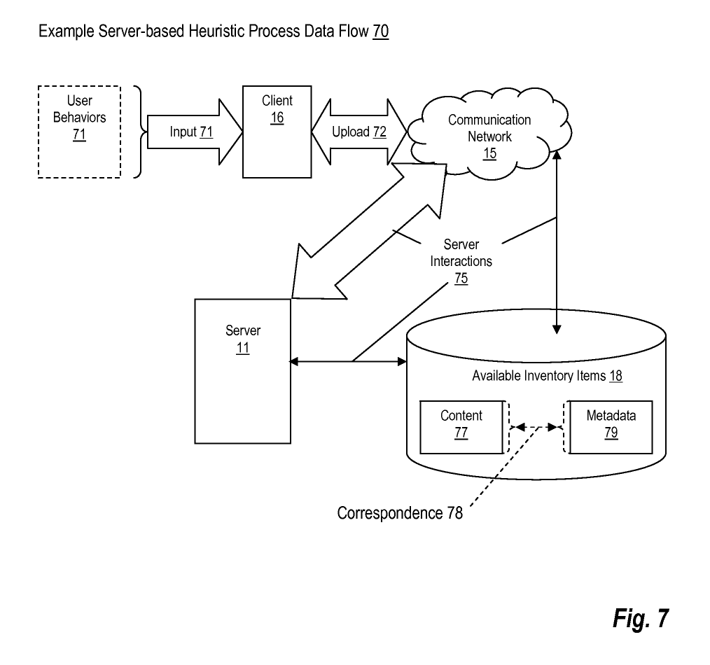

FIG. 7 depicts an example server based heuristic process data flow 70, according to an example embodiment of the present invention. User behaviors 76 are collected as inputs 71 to the client 16. Client 16 transmits the collected inputs as data uploads 72 to the network 15 and may also download data therefrom. The server 11 receives the upload data from the network 15 based on server interactions 75 therewith. The interactions 75 may also allow the server 11 to interact directly with the available item inventory 18. The available item inventory 18 stores content 77 related to the available items. The available item inventory 18 also stores metadata 79 related to the available items, with which the content may be indexed, addressed, stored, retrieved and/or accessed. A correspondence 78 may link content 77 and metadata 79 in relation to the item.

The server 11 may compute feedback values based on the levels of the objectifiers received in the transactions with client computers 16 in relation to one or more of the multiple items i. An example embodiment may be implemented in which the server 11 is programmed to set feedback values for each different rating objectifier experimentally and/or heuristically. The server 11 may thus ascribe (assign) a larger point value to a higher-rated feedback input than to a lower-rated feedback input. While the server 11 may ascribe a value of “90” to a high explicit feedback input such as a “5-star” rating for example, the server 11 may also ascribe less value to lower feedback inputs; thus the server 11 may ascribe a value of “1” (or another value less than the “90” value) to a mere “1-star” rating.

The server 11 may compute explicit feedback values based on user behaviors, besides, in addition to, or instead of explicit user ratings. For example, the server 11 may also compute explicit feedback values based on behaviors expressing that certain of the items i or items j are not of interest to the user for addition to the user's library lᵤ, or that the user requested (or attempted) to preview certain (e.g., one or more) of the items i, already read a certain e-book (or e.g., listened to a certain CD, watched a certain video, played a certain game, indicated that a legacy or print-based book has been read, or otherwise interacted with some particular media content item).

Not dissimilarly, the server 11 may also compute explicit feedback values based on behaviors expressing for example, that certain of the items comprise items the user has expressed an interest in acquiring for addition to the user's library (e.g., “wish-list” items), items the user has actually purchased for addition to the user's library, and/or items the user has acquired for the library independent of an actual purchase thereof such as items downloaded freely (e.g., free downloadable e-books).

Other user behaviors, such as browsing a webpage associated with the item or activating a link thereto may also comprise inputs operably useful to the server 11 for the behavior registration. An example embodiment may be implemented in which the link activating comprises clicking over a hyperlink with a user interface (UI) such as a mouse, keyboard, voice-actuated, GUI, haptically-actuated interface, haptic/GUI and/or another interface.

In an example embodiment, the server 11 may also receive transactional data, which the client computer 16 communicates to the server 11 in relation to media interaction significance data. Media interaction significance data comprise information reflecting a level of significance associated with each of the user's behaviors relating to each of the library items. The server 11 may compute a significance level for any/all user-item pairs based on a degree of interaction a user's behaviors imply, suggest or reflect with each of the items.

The degree of interaction may relate to duration of a time period. The time period may commence at a start time, and endure until an end time associated with of any given interaction a user has with a media instance. For example, the server 11 may register a time period between the start time stamp and an end time stamp of a particular user reading session with an e-book library item, transacted with the server 11 by the user's e-book reader. The server 11 may then ascribe a higher significance level to a longer duration reading period of a user's reading period with a certain e-book or other media than to a shorter duration thereof. The server 11 may also ascribe a higher significance level to longer duration reading periods of a first e-book item than to a shorter duration of a second e-book item and thus, to the first e-book in relation to the second.

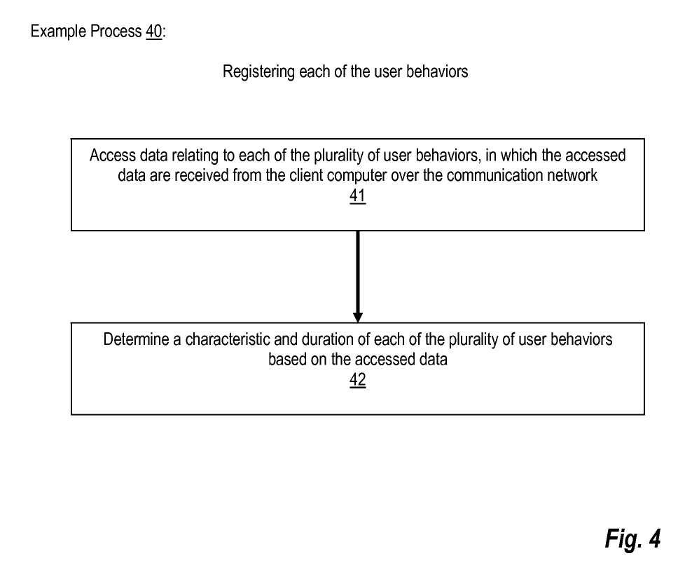

FIG. 4 depicts a flowchart of an example process 40 for registering each of the user behaviors. In step 41, data is accessed in relation to each of the multiple user behaviors. The accessed data are received from the client computer over the communication network. In step 42, a characteristic and duration are determined relating to each of the multiple user behaviors based on the accessed data.

The degree of interaction may relate to pairs of start events and finish events registered in relation to whole media content instances or to at least significant (or substantial) portions thereof. In ascribing the significance level, the server 11 may combine multiple or repeated start/finish events additively or multiplicatively, e.g., according to a business rule.

The degree of interaction may also relate to a behavior relating to a user bookmarking a library item or highlighting a portion thereof such as a word or phrase in an e-book, which the server 11 receives from an e-book reader. Further, the degree of interaction may relate to a behavior relating to a user sharing data about a media item on a social network.

The server 11 may combine any/all of the degrees of media interaction data in computing a significance level. The server 11 may combine the various interactions additively (or multiplicatively). For example, a value ascribed to an actual purchase of a user item may be combined with a value ascribed to a completion event to increase an item's overall significance level, media use (e.g., reading) durations may be combined additively. Repeated whole-item completion event values may, at some level, be combined multiplicatively with another value. The significance values may be assigned based on business rules, with which the server 11 may be programmed.

Further, an example embodiment is implemented in which the server 11 receives data in relation to media content similarity data. The server 11 receives computed (or may compute) the global media content similarity data in relation to explicit and implicit similarities between content of one or more items of the user library and content of each of the available inventory items. For media with text based content, the explicit global media content similarity may be computed using CF. Similarities may be determined between the text content of an e-book library item and text content of each of the available inventory items. The similarity may also be computed with comparisons between metadata associated with each of the library items and metadata associated with each of the available inventory items.

An example embodiment may be implemented in which text based similarity s_{T} (i,j) is computed using any of various techniques of information retrieval and library science, such as tf-idf (or TF/IDF; each abbreviating term frequency/inverse document frequency′) textual comparison. Metadata based measurements determine the metadata based similarity s_{M}(i,j) between the library items and the available inventory items by comparing metadata characterizing the items, such as “author,” “codes” (e.g., Dewey Decimal System code, Book Industry Standards and Communications ‘BISAC’ code, International Standard Book No. ‘ISBN’ codes, etc.), “genre,” “publisher,” “subject,” “title,” or the like.

In an example embodiment, the server 11 computes a final or overall similarity measurement s_{F}(i,j) between each of the library items i and each of the available inventory items j is computed according to Equation 2, below.

s_{F}(i,j)=αs(i,j)+βs_{T}(i,j)+γs_{M}(i,j) (Equation 2.)

Processing a solution to Equation 2 comprises computing a linear combination of the behavior based similarity measurement s(i,j), the text based similarity measurement s_{T} (i,j), and the metadata based similarity measurement s_{M}(i,j), each of which is weighted by a weighting factor α, β, and γ, respectively. The weighting factors α, β, and γ each represent numerical weighting values, which may be specific to a particular processing application.

Upon computing the final similarity measurement, the server 11 computes a recommendation list therewith for the user. The recommendation list comprises a listing of recommended items from the available inventory of items for the user to consider for subsequent inclusion in the user's library, such as a purchase recommendation. The recommendations for each of the inventory items i is based on the scoring or value ascribed to the final similarity measurement s_{F} computed for each available inventory item in relation to each of the items j of the user library lᵤ.

In step 36, the server 11 lists a recommendation list of the available inventory items for the user library based on the computed overall similarity score. In an example embodiment, the server 11 generates the recommendation list from the best scores computed in processing a CF solution rᵤ(i) to Equation 3, below.

$${r}_{U} ( i ) = {\sum }_{j ∈ {I}_{u}} {w}_{j , u} s ( j , i ) . \qquad ( Equation 3. )$$

In Equation 3, each of the items j in the user library lᵤ is weighted with a weight w_{i,u}. The items j are weighted according to a type, with which the item may be characterized. For example, a particular item j may comprise a “purchased” item type. The expression s(j,i) represents the overall similarity s_{F}(i,j) computed (e.g., according to Equation 3, above) between each pair of the items j of the user library lᵤ and each of the available inventory items i. Thus, the server 11 computes the scoring function rᵤ(i) as a weighted sum of items in the user library and the available inventory items.

A “purchase” type item in the user library may be weighted more significantly than an item acquired by the user freely for addition to the library, such as a “free download” or “free sample” type item. Thus, the actual purchase of an e-book by the user represents an investment by the user of the purchase cost of the e-book in the user's library. This registered purchase behavior type is thus ascribed more significance than a user merely accepting a free type download offer and adding a free e-book to the library without expending any investment therein.

The weight w_{i,u} may be ascribed to an item based on when the item was added to the user library. More recent purchases may be weighted more significantly then earlier purchase behaviors. For example, the server 11 may discount the weight of an item in the user library over time. Thus, the weighting factor w_{i,u} may diminish in value over time. An example embodiment may be implemented in which the server 11 discounts the weight of an item in the user library exponentially in relation to time, which has transpired between the purchase date of a library item, or a date/timestamp associated with the user's last interaction with the library item, and the present time.

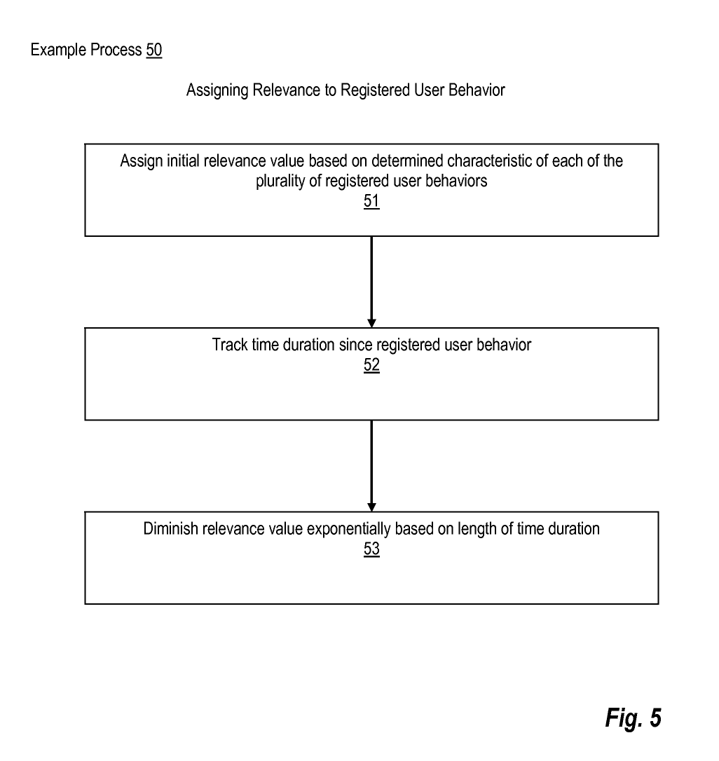

FIG. 5 depicts a flowchart for an example server implemented process 50 for assigning relevance to registered user behaviors, according to an embodiment of the present invention. In step 51, an initial relevance value is assigned based on a characteristic determined for each of the multiple user behaviors. In step 52, the duration of time is tracked from the date and time the latest user behavior was registered until a present time. In step 53, the assigned relevance value is diminished exponentially (or with some other function or rate scale) based on the length of the time duration.

Thus, an example embodiment is described in relation to a server implemented process for computing a recommendation list of items for a user of a client. Each of multiple behaviors performed by the user are registered in relation to each of a plurality of items of a library associated with the user. The server assigns a relevance factor for information associated with each of the registered user behaviors in relation to each of multiple items of an available inventory of items. A first similarity value is measured between each of the multiple user library items and each of the multiple available inventory items based on the assigned relevance factors. A second similarity value is measured between each of multiple pairs of all items based on content and a third similarity value is measured between each of the all multiple item pairs based on metadata. An overall similarity score between each of the multiple user library items and each of the multiple available inventory items is computed based on a sum of the first measured similarity value, the second content based similarity value and the third metadata based similarity value. A recommendation list of the available inventory items is listed for inclusion in the user library based on the computed overall similarity score.

Although example embodiments are described herein, it should become apparent from the foregoing disclosure to those skilled in the art that additions, equivalents, alternatives, variations and modifications of such embodiments and methods may be made without departing from the spirit and scope of the invention. It is intended that the scope or extent of embodiments of the present invention are defined in the claims below, equivalents thereof and any subsequent amendments thereto under the rules and principles of applicable law.

What is claimed is:

1. A server implemented method for computing a recommendation list for a user of a client computer, which interacts with the server over a communication network, the method comprising:
registering a plurality of behaviors performed by the user in relation to each of a plurality of items of a library associated with the user;
assigning a respective relevance factor for information associated with each registered user behavior in relation to each of a plurality of items of an available inventory items;
measuring a first similarity value between each of the plurality of user library items and each of the plurality of available inventory items based on assigned relevance factors;
measuring a second similarity value between each of a plurality of pairs of all items based globally on content associated with each item of the plurality of item pairs and a third similarity value between each of the plurality of pairs of all items based globally on metadata associated with each item of the plurality of item pairs;
computing an overall similarity score between each of the plurality of user library items and each of the plurality of available inventory items based on a sum of the first measured similarity value, the second content based similarity value and the third metadata based similarity value; and
generating the recommendation list of the available inventory items for the user library based on the computed overall similarity score.

2. The server implemented method as recited in claim 1 wherein the registering the plurality of user behaviors comprises:
accessing data relating to each of the plurality of user behaviors wherein the accessed data are received from the client computer over the communication network; and
determining a characteristic and duration of each of the plurality of user behaviors based on the accessed data.

3. The server implemented method as recited in claim 2 wherein the characteristic relates to a type of the behavior and wherein the assigning the respective relevance factor is based on the determined type of user behavior.

4. The server implemented method as recited in claim 2 wherein the duration comprises a length of time associated with the user behavior and wherein the assigning a respective relevance factor is based on the associated length of time.

5. The server implemented method as recited in claim 4 wherein the length of time commences with a latest user interaction with the item and endures until a present time, and wherein a value of the relevance factor diminishes over the length of time.

6. The server implemented method as recited in claim 3 wherein a determined user behavior type comprises an explicit action related to one or more of:
a user purchase event associated with one or more of the plurality of user library items;
a user feedback in relation to one or more of the plurality of user library items;
a user rating score relating to one or more of the plurality of user library items;
a user preview event associated with one or more of the plurality of user library items;
a user ‘already used’ indication returned in relation to one or more of the plurality of user library items or the plurality of available inventory items;
a user ‘interested’ indication returned in relation to a one or more of the available inventory items;
a user ‘free download’ event associated with one or more of the available inventory items in relation to an inclusion of the freely downloaded available inventory items to the user library;
a user browsing event and a duration thereof associated with a webpage associated with the item; and
a user event in relation to activating a link associated with one or more of the available inventory items.

7. The server implemented method as recited in claim 2 wherein one or more of the determined type of user behavior or duration thereof relates to one or more of:
a start time and an end time of a session, which comprises an interaction between the user and the item;
an event relating to the user completing the use of an entire item, after commencing the use thereof; and
an event relating to the user highlighting, selecting, bookmarking or linking to at least a portion of the item.

8. A non-transitory computer readable storage medium comprising instructions tangibly stored therewith, which when executed by a computer processor cause, control or program a server computer to perform a process for computing a recommendation list of items for a user of a client computer, which interacts with the server computer over a communications network, the process comprising the execution steps of:
registering a plurality of behaviors performed by the user in relation to each of a plurality of items of a library associated with the user;
assigning a respective relevance factor for information associated with each registered user behavior in relation to each of a plurality of items of an available inventory items;
measuring a first similarity value between each of the plurality of user library items and each of the plurality of available inventory items based on assigned relevance factors;
measuring a second similarity value between each of a plurality of pairs of all items based globally on content associated with each item of the plurality of item pairs and a third similarity value between each of the plurality of pairs of all items based globally on metadata associated with each item of the plurality of item pairs;
computing an overall similarity score between each of the plurality of user library items and each of the plurality of available inventory items based on a sum of the first measured similarity value, the second content based similarity value and the third metadata based similarity value; and
generating the recommendation list of the available inventory items for the user library based on the computed overall similarity score.

9. The non-transitory computer readable storage medium as recited in claim 8 wherein the registering the plurality of user behaviors comprises:
accessing data relating to each of the plurality of user behaviors wherein the accessed data are received from the client computer over the communication network; and
determining a characteristic and duration of each of the plurality of user behaviors based on the accessed data.

10. The non-transitory computer readable storage medium as recited in claim 9 wherein the characteristic relates to a type of the behavior and wherein the assigning the respective relevance factor is based on the determined type of user behavior.

11. The non-transitory computer readable storage medium as recited in claim 9 wherein the duration comprises a length of time associated with the user behavior and wherein the assigning a respective relevance factor is based on the associated length of time.

12. The non-transitory computer readable storage medium as recited in claim 11 wherein the length of time commences with a latest user interaction with the item and endures until a present time, and wherein a value of the relevance factor diminishes over the length of time.

13. The non-transitory computer readable storage medium as recited in claim 10 wherein a determined type of user behavior comprises an explicit action related to one or more of:
a user purchase event associated with one or more of the plurality of user library items;
a user feedback in relation to one or more of the plurality of user library items;
a user rating score relating to one or more of the plurality of user library items;
a user preview event associated with one or more of the plurality of user library items;
a user ‘already used’ indication returned in relation to one or more of the plurality of user library items or the plurality of available inventory items;
a user ‘interested’ indication returned in relation to a one or more of the available inventory items;
a user ‘free download’ event associated with one or more of the available inventory items in relation to an inclusion of the freely downloaded available inventory items to the user library;
a user browsing event and a duration thereof associated with a webpage associated with the item; and
a user event in relation to activating a link associated with one or more of the available inventory items.

14. The non-transitory computer readable storage medium as recited in claim 10 wherein one or more of the determined type of user behavior or duration thereof relates to one or more of:
a start time and an end time of a session, which comprises an interaction between the user and the item;
an event relating to the user completing the use of an entire item, after commencing the use thereof; and
an event relating to the user highlighting, selecting, bookmarking or linking to at least a portion of the item.

15. A server computer apparatus, the server comprising:
at least one processor; and
a non-transitory computer readable storage medium comprising instructions tangibly stored therewith, which when executed by the at least one processor causes, controls or programs the server computer to perform a process for computing a recommendation list of items for a user of a client computer, which interacts with the server computer over a communications network, the process comprising the execution steps of:
registering a plurality of behaviors performed by the user in relation to each of a plurality of items of a library associated with the user;
assigning a respective relevance factor for information associated with each registered user behavior in relation to each of a plurality of items of an available inventory items;
measuring a first similarity value between each of the plurality of user library items and each of the plurality of available inventory items based on assigned relevance factors;
measuring a second similarity value between each of a plurality of pairs of all items based globally on content associated with each item of the plurality of item pairs and a third similarity value between each of the plurality of pairs of all items based globally on metadata associated with each item of the plurality of item pairs;
computing an overall similarity score between each of the plurality of user library items and each of the plurality of available inventory items based on a sum of the first measured similarity value, the second content based similarity value and the third metadata based similarity value; and
generating the recommendation list of the available inventory items for the user library based on the computed overall similarity score.

16. The server computer apparatus as recited in claim 15 wherein the registering the plurality of user behaviors comprises:
accessing data relating to each of the plurality of user behaviors wherein the accessed data are received from the client computer over the communication network; and
determining a characteristic and duration of each of the plurality of user behaviors based on the accessed data.

17. The server computer apparatus as recited in claim 16 wherein the characteristic relates to a type of the behavior and wherein the assigning the respective relevance factor is based on the determined type of user behavior.

18. The server computer apparatus as recited in claim 16 wherein the duration comprises a length of time associated with the user behavior, wherein the assigning a respective relevance factor is based on the associated length of time wherein the length of time commences with a latest user interaction with the item and endures until a present time, and wherein a value of the relevance factor diminishes over the length of time.

19. The server computer apparatus as recited in claim 16 wherein the determined type of user behavior comprises an explicit action related to one or more of:
a user purchase event associated with one or more of the plurality of user library items;
a user feedback in relation to one or more of the plurality of user library items;
a user rating score relating to one or more of the plurality of user library items;
a user preview event associated with one or more of the plurality of user library items;
a user ‘already used’ indication returned in relation to one or more of the plurality of user library items or the plurality of available inventory items;
a user ‘interested’ indication returned in relation to a one or more of the available inventory items;
a user ‘free download’ event associated with one or more of the available inventory items in relation to an inclusion of the freely downloaded available inventory items to the user library;
a user browsing event and a duration thereof associated with a webpage associated with the item; and
a user event in relation to activating a link associated with one or more of the available inventory items.

20. The server computer apparatus as recited in claim 16 wherein one or more of the determined user behavior type or duration thereof relates to one or more of:
a start time and an end time of a session, which comprises an interaction between the user and the item;
an event relating to the user completing the use of an entire item, after commencing the use thereof; and
an event relating to the user highlighting, selecting, bookmarking or linking to at least a portion of the item.

21. The server computer apparatus as recited in claim 16 wherein one or more of the plurality of user library items or the available inventory items comprises content related to at least one of:
an electronic (e-) book and wherein the client computer comprises an apparatus, which is programmed or configured operably as an e-book reader; or
media content, which comprises one or more of text, audio, video, graphic, cinema, game, or mixed media and wherein the client computer comprises an apparatus, which is programmed or configured operably as player of the media content.
